(19) United States
(12) Patent Application Publication
(10) Pub. No.: US 2025/0219269 A1
(43) Pub. Date: Jul. 3, 2025

(54) METHOD FOR DISPOSING OF BATTERY AND BATTERY TREATMENT SYSTEM

(71) Applicant: TOYOTA JIDOSHA KABUSHIKI KAISHA, Toyota-shi (JP)

(72) Inventors: Hiroshi SUYAMA, Mishima-shi (JP); Fuminori MIZUNO, Miyoshi-shi (JP)

(73) Assignee: TOYOTA JIDOSHA KABUSHIKI KAISHA, Toyota-shi (JP)

(21) Appl. No.: 18/980,003

(22) Filed: Dec. 13, 2024

(30) Foreign Application Priority Data
Dec. 28, 2023 (JP) 2023-223422

(51) Int. Cl. H01M 50/571; H01M 10/44; H01M 10/54; H01M 50/562

(52) U.S. Cl. CPC H01M 50/571; H01M 10/44; H01M 50/562; H01M 10/54

(57) ABSTRACT

A main object of the present disclosure is to provide a method for disposing of a battery, with which the battery can be deactivated well. The present disclosure achieves the object by providing a method for disposing of a battery, the method including: a soaking step of soaking a battery including an Al terminal in a treatment liquid to decrease a voltage of the battery by causing outer short circuit through the treatment liquid, wherein the treatment liquid contains water, a supporting salt, and an additive that prevents the Al terminal from eluting; and a concentration of the additive in the treatment liquid is a minimum concentration C_{MIN}, that is capable of preventing the Al terminal from eluting, or more.

### TECHNICAL FIELD

The present disclosure relates to a method for disposing of a battery and a battery treatment system.

Background Art

A battery usually includes a terminal configured to take out electricity from an electrode body that is a power generating element. For example, Patent Literature 1 discloses a battery module that includes a laminate flat exterior battery including a cathode terminal lead and an anode terminal lead, wherein the cathode terminal lead is made of aluminum. Also, Patent Literature 2 discloses a discharging method for a discarded battery, wherein discharging is performed by soaking at least a cathode terminal and an anode terminal of a charged discarded battery in a aqueous solution in which an alkali metal weak acid salt is dissolved.

### CITATION LIST

### Patent Literatures

Patent Literature 1: Japanese Patent Application Laid-Open (JP-A) No. 2007-257849

Patent Literature 2: JP-A No. 2005-347162

### SUMMARY OF DISCLOSURE

### Technical Problem

Upon recycling a battery, it is desired to decrease the remaining voltage of the battery and deactivate the battery. Examples of the method for deactivating the battery may include a method in which the battery is soaked in a treatment liquid (such as salt water) to cause outer short circuit. In a case of the battery including an aluminum terminal (Al terminal), it may be difficult to deactivate the battery well since the Al terminal is deteriorated by the treatment liquid.

The present disclosure has been made in view of the above circumstances, and a main object thereof is to provide a method for disposing of a battery, with which the battery can be deactivated well.

### Solution to Problem

[1] A method for disposing of a battery, the method comprising:
a soaking step of soaking a battery including an Al terminal in a treatment liquid to decrease a voltage of the battery by causing outer short circuit through the treatment liquid, wherein
the treatment liquid contains water, a supporting salt, and an additive that prevents the Al terminal from eluting; and
a concentration of the additive in the treatment liquid is a minimum concentration C_{MIN}, that is capable of preventing the Al terminal from eluting, or more.

[2] The method for disposing of a battery according to [1], wherein the additive includes a phosphate-based anion, a silicate-based anion, an imide-based anion, or a carboxylic acid-based anion, as an anion component.

[3] The method for disposing of a battery according to [2], wherein the phosphate-based anion is a phosphate ion, a phosphite ion, a hypophosphite ion, or a polyphosphate ion.

[4] The method for disposing of a battery according to [2], wherein the silicate-based anion is an orthosilicate ion, a methsilicate ion, or a polysilicate ion.

[5] The method for disposing of a battery according to any one of [1] to [4], wherein the additive includes an alkali metal ion as a cation component.

[6] The method for disposing of a battery according to [5], wherein the alkali metal ion is a potassium ion.

[7] The method for disposing of a battery according to any one of [1] to [6], wherein the concentration of the additive in the treatment liquid is 0.5 mol/kg or more.

[8] The method for disposing of a battery according to any one of [1] to [7], wherein the concentration of the additive in the treatment liquid is 1.0 mol/kg or more.

[9] The method for disposing of a battery according to any one of [1] to [8], wherein a temperature of the treatment liquid in the soaking step is 0°° C. or more and 60°° C. or less.

[10] The method for disposing of a battery according to any one of [1] to [9], wherein the battery includes a laminate type outer package.

[11] The method for disposing of a battery according to

any one of [1] to [10], wherein the battery is a solid state battery.

[12] A battery treatment system comprising:
a treating bath configured to perform a treatment to a battery including an Al terminal by a treatment liquid that contains water, a supporting salt, and an additive that prevents the Al terminal from eluting;
a monitoring device that monitors a concentration of the additive in the treatment liquid;
a judging device that judges a concentration of the additive in the treatment liquid; and
a concentration adjusting device that adjusts a concentration of the additive in the treatment liquid, wherein
the judging device judges whether a concentration of the additive is a threshold value or more or not based on the concentration of the additive obtained by the monitoring device; and
when the judging device judges a concentration of the additive is less than the threshold value, the concentration adjusting device puts the additive in the treating bath to adjust the concentration of the additive to a minimum concentration C_{MIN}, that is capable of preventing the Al terminal from eluting, or more.

[13] The battery treatment system according to [12], wherein the monitoring device further monitors a temperature of the treatment liquid; and
the judging device judges whether a concentration of the additive is a threshold value or more or not based on the concentration of the additive and the temperature of the treatment liquid obtained by the monitoring device.

### Advantageous Effects of Disclosure

The present disclosure exhibits an effect of deactivating a battery well.

### BRIEF DESCRIPTION OF DRAWINGS

FIG. 1A is a schematic plane view and FIG. 1B is a schematic side view exemplifying the battery in the present disclosure.

FIG. 2 is a schematic side view exemplifying the method for disposing of a battery in the present disclosure.

FIGS. 3A and 3B are schematic cross-sectional views exemplifying the electrode body in the present disclosure.

FIG. 4 is an explanatory view exemplifying the battery treatment system in the present disclosure.

FIG. 5 is a flow chart exemplifying a treatment flow of the battery treatment system in the present disclosure.

FIG. 6 is the result of a LSV measurement to a cell produced in Reference Comparative Example 1.

FIGS. 7A to 7D are the results of LSV measurements to cells produced in Example 1-1, Example 1-2, and Example 1-3.

FIGS. 8A to 8D are the results of LSV measurements to cells produced in Comparative Example 2-1, Example 2-1, Example 2-2, and Example 2-3.

FIGS. 9A to 9D are the results of LSV measurements to cells produced in Comparative Example 3-1, Comparative Example 3-2, Example 3-1, and Example 3-2.

FIG. 10 is the result of a LSV measurement to a cell produced in Comparative Example 4-1.

FIG. 11 is a graph showing a relation between the concentration of the additive and the current density. FIG. 12 is the result of a LSV measurement to a cell produced in Reference Comparative Example 2.

FIGS. 13A to 13D are the results of LSV measurements to cells produced in Example 4-1, Example 4-2, Example 5-1, and Example 6-1.

### DESCRIPTION OF EMBODIMENTS

The method for disposing of a battery and the battery treatment system in the present disclosure will be hereinafter explained in details.

### A. Method for Disposing of Battery

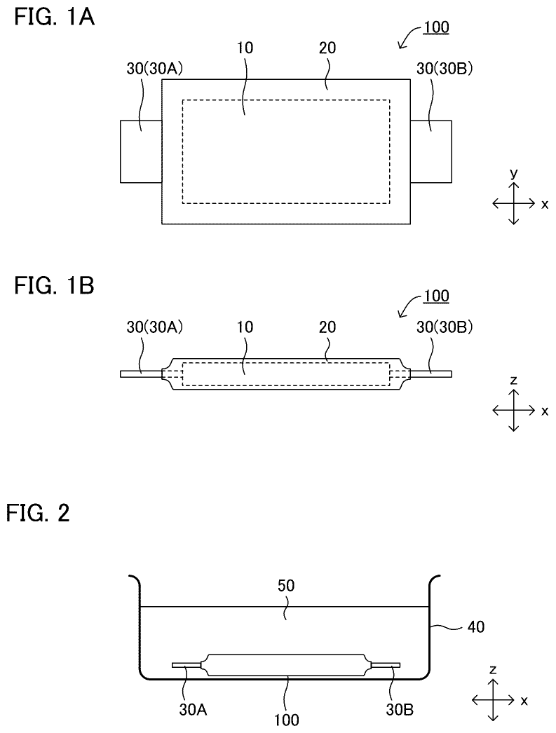

FIG. 1A is a schematic plane view and FIG. 1B is a schematic side view exemplifying the battery in the present disclosure. As shown in FIGS. 1A and 1B, battery 100 includes electrode body 10, outer package 20 covering the electrode body 10, and terminal 30 (30A, 30B) that is electrically connected to the electrode body 10 and is partially exposed from the outer package 20. At least one of the terminal 30A and the terminal 30B is an Al terminal.

FIG. 2 is a schematic side view exemplifying the method for disposing of a battery in the present disclosure. As shown in FIG. 2, treatment liquid 50 is put in treating bath 40, and the battery 100 is soaked in the treatment liquid 50. The terminal 30A and the terminal 30B are conducted through the treatment liquid 50 to cause outer short circuit, and thereby the voltage of the battery 100 is decreased. In the present disclosure, the treatment liquid 50 contains an additive that prevents the Al terminal from eluting in the specified concentration.

According to the present disclosure, since the treatment liquid contains the additive that prevents the Al terminal from eluting in the specified concentration, the battery can be deactivated well. As described above, upon recycling a battery, it is desired to decrease the remaining voltage of the battery to deactivate the battery. By deactivating the battery, later steps such as a battery disassembling step can be safely performed. Examples of the method for deactivating the battery may include a method in which the battery is soaked in a treatment liquid (such as salt water) to cause outer short circuit. In a case of the battery including an Al terminal, the Al terminal is deteriorated by the treatment liquid, and it may be difficult to deactivate the battery well. For example, corrosion (elution) of the Al terminal is caused by the treatment liquid, and when the Al terminal exposed from the outer package slips, the decrease in the remaining voltage due to outer short circuit may not be caused or the decrease speed may be significantly slowed down.

In contrast, in the present disclosure, the additive that prevents the Al terminal from eluting is used. Al (Al ions) eluted to the treatment liquid from the Al terminal bonds to an anion of the additive present in the treatment liquid, and is deposited on the surface of the Al terminal. Thereby, a passive state film is formed on the surface of the Al terminal. When the passive state film works as a protective film, the eluting speed of Al eluting from the Al terminal to the treatment liquid can be slowed down. When the battery is soaked in the treatment liquid including such an additive, the outer short circuit can be maintained, and the battery can be deactivated well.

The method for disposing of a battery in the present disclosure includes a soaking step of soaking a battery including an Al terminal in a treatment liquid to decrease a voltage of the battery by causing outer short circuit through the treatment liquid.

### 1. Treatment Liquid

The treatment liquid in the present disclosure contains water, a supporting salt, and an additive that prevents the Al terminal from eluting.

The supporting salt is used to improve the conductivity of the treatment liquid. Also, the supporting salt usually does not include a function to prevent the Al terminal from eluting. The supporting salt includes a cation component and an anion component. Examples of the cation component of the supporting salt may include an alkali metal ion such as Na and K; and an alkali earth metal ion such as Mg and Ca. Meanwhile, examples of the anion component of the supporting salt may include a chloride ion. Specific examples of the supporting salt may include NaCl, KCl, MgCl₂, and CaCl₂. Also, the treatment liquid may contain just one kind of the supporting salt, and may contain two kinds or more of the supporting salt.

At least a part of the supporting salt is dissolved in water. The concentration of the supporting salt in the treatment liquid is not particularly limited, but for example, it is 0.01 mol/kg or more and 5.0 mol/kg or less, and may be 0.1 mol/kg or more and 3.0 mol/kg or less. In the present disclosure, the concentration of the supporting salt is defined as a ratio of number of moles of the supporting salt with respect to the weight of water included present disclosure treatment liquid.

The additive is used to prevent the Al terminal from eluting. Also, the additive includes a cation component and an anion component. The anion component of the additive bonds to Al (Al ions) eluted from the Al terminal to the treatment liquid, and deposited on the surface of the Al terminal. Examples of the anion component of the additive may include a phosphate-based anion, a silicate-based anion, an imide-based anion, and a carboxylic acid-based anion.

The phosphate-based anion is an anion including phosphorus (P) and oxygen (O). Examples of the phosphate-based anion may include a phosphate ion (PO₄³⁻), a phosphite ion (HPO₃²⁻), and a hypophosphite ion (H₂PO₂⁻). Also, the phosphate-based anion may be a polyphosphate ion. The polyphosphate ion is an ion including two or more phosphorus (P). Examples of the polyphosphate ion may include P₂O₇⁴⁻, P₃O₉⁻³⁻, and P₃O₁₀⁵⁻.

The silicate-based anion is an anion including silicon (Si) and oxygen (O). Examples of the silicate-based anion may include an orthosilicate ion (SiO₄⁴⁻), and a methsilicate ion (SiO₃²⁻). Also, the silicate-based anion may be a polysilicate ion. The polysilicate ion is an ion including two or more of silicon (Si). Examples of the polysilicate ion may include Si₂O₇⁶⁻.

Examples of the imide-based anion may include a bis (trifluoromethanesulfonyl) imide ion (TFSI ion, (CF₃SO₂)₂N⁻), and bis (sulfonyl) imide ion (FSI ion, (FSO₂)₂N⁻). Also, examples of the carboxylic acid-based anion may include an acetic acid ion (CH₃COO⁻).

Examples of the cation component of the additive may include an alkali metal ion such as Na and K; and an alkali earth metal ion such as Mg and Ca. Among those, the cation component of the additive is preferably a potassium ion. The reason therefor is that the solubility of the additive to water improves.

Specific examples of the additive may include K₃PO₄, Na₃PO₄, Mg₃(PO₄)₂, Ca₃(PO₄)₂; K₄P₂O₇, Na₄P₂O₇, Mg₂P₂O₇, Ca₂P₂O₇; K₄SiO₄, Na₄SiO₄, Mg₂SiO₄, Ca₂SiO₄; K₂SiO₃, Na₂SiO₂; K(CF₃SO₂)₂N, Na(CF₃SO₂)₂N; K(FSO₂)₂N, Na(FSO₂)₂N; CH₃COOK, CH₃COONa, Mg(CH₃COO)₂, Ca(CH₃COO)₂. The treatment liquid may contain just one kind of the additive, and may contain two kinds or more of the additive.

At least a part of the additive is dissolved in water. The concentration of the additive in the treatment liquid is a minimum concentration C_{MIN}, that is capable of preventing the Al terminal from eluting, or more. When the concentration of the additive is too low, the passive state film may not be formed on the surface of the Al terminal, but on the contrary, the elution of the Al terminal may be promoted. Thus, the minimum concentration capable of preventing the Al terminal from eluting is defined as C_{MIN}, and the concentration of the additive in the treatment liquid is adjusted to the minimum concentration C_{MIN} or more. The minimum concentration C_{MIN} varies depending on the kind of the additive, and thus, by using the additive to be used in the treatment liquid, a prior experiment changing its concentration is performed, and by comparing to the treatment liquid not using the additive, the minimum concentration C_{MIN} is determined. Also, since the minimum concentration C_{MIN} is also influenced by the temperature of the treatment liquid in the soaking step. The prior experiment needs consideration of the temperature of the treatment liquid. Also, as the prior experiment, as in later described Examples, it is preferable to perform a linear sweep voltammetry (LSV) measurement.

The concentration of the additive in the treatment liquid is, for example, 0.5 mol/kg or more, and may be 1.0 mol/kg or more. Meanwhile, the concentration of the additive in the treatment liquid is not particularly limited as long as the concentration is capable of preventing the Al terminal from eluting, but for example, it is 10 mol/kg or less. In the present disclosure, the concentration of the additive is defined as a ratio of number of moles of the additive with respect to the weight of water included in the treatment liquid.

The treatment liquid may contain acid or alkali as required. By adding acid or alkali, for example, it is possible to improve the solubility of the additive. Also, examples of the method for preparing the treatment liquid may include a method in which the supporting salt and the additive are dissolved in water.

### 2. Battery

As shown in FIGS. 1A and 1B, the battery 100 usually includes the electrode body 10, the outer package 20 covering the electrode body 10, and the terminal 30 (30A, 30B) that is electrically connected to the electrode body 10, and is partially exposed from the outer package 20. Also, at least one of the terminal 30A and the terminal 30B is an Al terminal.

In the present disclosure, a unit configured by an electrode body, an outer package, and a pair of terminals may be referred to as a “cell”. The battery to be disposed of by the disposing method in the present disclosure may include one cell, and may include two or more of cells.

### (1) Terminal

The battery in the present disclosure usually includes a cathode terminal and an anode terminal. At least one of the cathode terminal and the anode terminal is an Al terminal. Among them, at least the cathode terminal is preferably the Al terminal. The Al terminal is a terminal containing at least aluminum. The Al terminal preferably contains aluminum as a main component of the metal component. In the Al terminal, the proportion of the aluminum with respect to all the metal components is, for example, 50 weight % or more, may be 70 weight % or more, and may be 90 weight % or more. Examples of the material of the Al terminal may include aluminum and an aluminum alloy.

There are no particular limitations on the shape of the Al terminal. Also, there are no particular limitations on the thickness of the Al terminal either, but the thinner the Al terminal, the greater the influence of the deterioration of the Al terminal by the treatment liquid. The thickness of the Al terminal means the length of the Al terminal in a normal direction of a main surface (surface with the largest area) of the Al terminal. The thickness of the Al terminal is, for example, 5 mm or less, may be 3 mm or less, may be 1 mm or less, may be 0.8 mm or less, and may be 0.6 mm or less. Meanwhile, the thickness of the Al terminal is, for example, 0.1 mm or more.

(2) Electrode body

The electrode body in the present disclosure works as a power generating element of the battery. The electrode body usually includes layers in an order of, a cathode current collector, a cathode active material layer, an electrolyte layer, an anode active material layer, and an anode current collector, in a thickness direction.

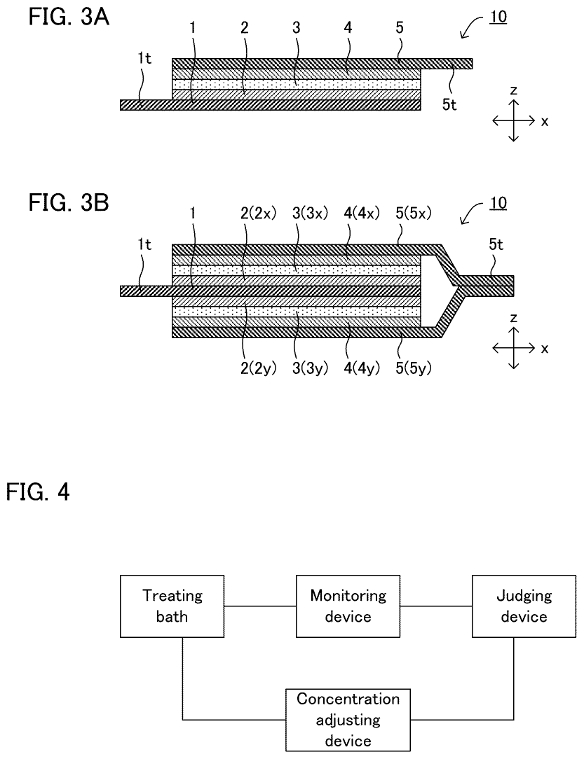

FIGS. 3A and 3B are schematic cross-sectional views exemplifying the electrode body in the present disclosure. Electrode body 10 shown in FIG. 3A includes layers in an order of, anode current collector 1, anode active material layer 2, electrolyte layer 3, cathode active material layer 4 and cathode current collector 5, in a thickness direction (z direction). Also, the anode current collector 1 includes anode tab 1t configured to connect to an anode terminal (not illustrated), and the cathode current collector 5 includes cathode tab 5t configured to connect to a cathode terminal (not illustrated).

The electrode body 10 illustrated in FIG. 3B includes, anode current collector 1, and layers arranged in the order in the thickness direction (z direction) from one surface of the anode current collector 1, that are anode active material layer 2x, electrolyte layer 3x, cathode active material layer 4x and cathode current collector 5x, and layers arranged in the order in the thickness direction (z direction) from the other surface of the anode current collector 1, that are anode active material layer 2y, electrolyte layer 3y, cathode active material layer 4y and cathode current collector 5y.

In FIGS. 3A and 3B, the cathode tab 5t and the anode tab 1t are arranged so as to face to each other in the side surface of the electrode body 10 to form a so-called double-tab structure. Meanwhile, although not illustrated in particular, the cathode tab and the anode tab may be arranged on the same side surface of the electrode body to form a so-called single-tab structure. Also, as shown in FIGS. 3A and 3B, the electrode body 10 may be in a sheet shape. Also, although not illustrated in particular, the electrode body may be in a winding shape. Also, a unit configured by a cathode active material layer, an electrolyte layer and an anode active material layer may be referred to as a “power generating unit”. The electrode body in the present disclosure may include one of the power generating unit, and may include a plurality of the power generating unit. A plurality of the power generating unit is usually layered in a thickness direction.

The cathode active material layer contains at least a cathode active material. The cathode active material layer may further contain at least one of an electrolyte, a conductive material, and a binder. Examples of the cathode active material may include an oxide active material. Examples of the oxide active material may include a rock salt bed type active material such as LiNi_{1/3}Co_{1/3}Mn_{1/3}O₂, and LiNi_{0.8}Co_{0.15}Al_{0.05}O₂; a spinel type active material such as LiMn₂O₄; and an olivine type active material such as LiFePO₄. Examples of the shape of the cathode active material may include a granular shape.

The electrolyte may be a solid electrolyte and may be an electrolyte solution (liquid electrolyte). The solid electrolyte may be an organic solid electrolyte such as a gel electrolyte, and may be an inorganic solid electrolyte such as a sulfide solid electrolyte and an oxide solid electrolyte. Among those, the solid electrolyte is preferably a sulfide solid electrolyte. The reason therefor is its high ion conductivity. Meanwhile, there are no particular limitations on the electrolyte solution, and known electrolytes may be used. Also, examples of the conductive material may include a carbon material. Also, examples of the binder may include a rubber-based binder and a fluoride-based binder.

The anode active material layer contains at least an anode active material. The anode active material layer may further contain at least one of an electrolyte, a conductive material, and a binder. Examples of the anode active material may include a metal active material such as Li, Si and Sn, a carbon active material such as graphite, and an oxide active material such as Li₄Ti₅O₁₂.

The electrolyte layer is arranged between the cathode active material layer and the anode active material layer, and contains at least an electrolyte. The electrolyte may be a solid electrolyte and may be an electrolyte solution. The electrolyte is in the same contents as those described above. The electrolyte layer may be a solid electrolyte layer containing a solid electrolyte. Further, the solid electrolyte is preferably a sulfide solid electrolyte. Also, in general, a battery including the solid electrolyte layer containing an inorganic solid electrolyte is called a solid state battery. The solid state battery may be a semisolid state battery and may be an all solid state battery. In the present disclosure, the semisolid state battery is a battery in which the electrolyte layer includes an inorganic solid electrolyte and a liquid component (such as ionic solution). In the present disclosure, the all solid state battery is a battery in which the electrolyte layer includes only the inorganic solid electrolyte as the electrolyte.

The cathode current collector collects currents of the cathode active material layer. Examples of the material for the cathode current collector may include a metal such as aluminum, SUS, and nickel. Examples of the shape of the cathode current collector may include a foil shape. The cathode current collector usually includes a cathode tab configured to connect to the cathode terminal. Also, the anode current collector collects currents of the anode active material layer. Examples of the material for the anode current collector may include a metal such as copper, SUS, and nickel. Examples of the shape of the anode current collector may include a foil shape. The anode current collector usually includes an anode tab configured to connect to the anode terminal.

### (3) Outer Package

The outer package in the present disclosure may be a laminate type outer package, and may be a case type outer package. The laminate type outer package is also called a pouch type outer package, and is an outer package using a laminate film. The laminate type outer package includes at least an inner side resin layer and a metal layer. The inner side resin layer works as a sealant layer. The inner side resin layer preferably contains a thermoplastic resin. Examples of the thermoplastic resin may include polyolefin such as polyethylene and polypropylene; polystyrene; and polyvinyl chloride. The thickness of the inner side resin layer is not particularly limited, and for example, it is 30 μm or more and 150 μm or less.

The metal layer works as a barrier layer. Examples of the metal used in the metal layer may include aluminum, an aluminum alloy, and stainless steel. The thickness of the metal layer is not particularly limited, and for example, it is 20 μm or more and 100 μm or less. Also, the laminate type outer package may include an outer side resin layer in the opposite side to the inner side resin layer on the basis of the metal layer. The outer side resin layer works as an insulating layer or a protective layer. The outer side resin layer preferably contains a thermoplastic resin. Examples of the thermoplastic resin may include polyester such as polyethylene terephthalate (PET); and nylon. The thickness of the outer side resin layer is not particularly limited, and for example, it is 20 μm or more and 100 μm or less.

The case type outer package is, for example, an outer package made of metal. Examples of the material configuring the case type outer package may include a metal aluminum and an aluminum alloy. Also, a plastic processing may be performed to aluminum or an aluminum alloy, and the material processed and cured may be used. Also, the thickness of the case type outer package is not particularly limited, and selected to the extent the desired rigidity can be obtained.

### (4) Battery

Examples of the battery in the present disclosure may include a secondary battery such as a lithium ion secondary battery. Also, examples of the applications of the battery before performing the disposing method in the present disclosure may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably a battery that was used as a power source for driving hybrid electric vehicles (HEV), plug-in hybrid electric vehicles (PHEV), and battery electric vehicles (BEV). It may be a battery that was used as a power source for moving bodies other than vehicles (such as rail road transportation, vessel and airplane), and may be a battery that was used as a power source for electronic products such as information processing equipment.

### 3. Soaking Step

In the soaking step of in the present disclosure, a battery including an Al terminal is soaked present disclosure treatment liquid to decrease a voltage of the battery by causing outer short circuit through the treatment liquid. In specific, as shown in FIG. 2, treatment liquid 50 is put in treating bath 40, and battery 100 is soaked in the treatment liquid 50.

There are no particular limitations on the temperature of the treatment liquid in the soaking step. For example, since the freezing point of salt water is about −20° C., the temperature of the treatment liquid is preferably −20° C. or more, and more preferably 0° C. or more. Meanwhile, the temperature of the treatment liquid is, for example, 60° C. or less and may be 40° C. or less. Also, the temperature of the treatment liquid in the soaking step may be the same as the room temperature.

There are no particular limitations on the treatment time in the soaking step, but from the view point of workability, for example, it is preferably 1 hour or more and 50 hours or less, and more preferably 2 hours or more and 25 hours or less.

### B. Battery Treatment System

As shown in FIG. 4, the battery treatment system in the present disclosure includes a treating bath, a monitoring device, a judging device, and a concentration adjusting device. The treating bath is a facility for treating a battery. The monitoring device monitors a concentration of the additive in the treatment liquid. The judging device judges a concentration of the additive in the treatment liquid. The concentration adjusting device adjusts a concentration of the additive in the treatment liquid. Further, the judging device judges whether a concentration of the additive is a threshold value or more or not based on the concentration of the additive obtained by the monitoring device. When the judging device judges a concentration of the additive is less than the threshold value, the concentration adjusting device puts the additive in the treating bath to adjust the concentration of the additive to a minimum concentration C_{MIN}, that is capable of preventing the Al terminal from eluting, or more.

According to the present disclosure, by adjusting the concentration of the additive in the treatment liquid to the minimum concentration C_{MIN}, that is capable of preventing the Al terminal from eluting, or more, the battery can be deactivated well.

### 1. Treating Bath

The treating bath in the present disclosure is a facility configured to perform a treatment to a battery including an Al terminal by a treatment liquid that contains water, a supporting salt, and an additive that prevents the Al terminal from eluting. As shown in above described FIG. 2, by putting treatment liquid 50 in treating bath 40, and soaking the battery 100 in the treatment liquid 50, the battery 100 can be treated by the treatment liquid 50.

The treating bath is not particularly limited, if it is a facility capable of storing the battery and the treatment liquid. Also, the battery and the additive are in the same contents as those described in “A. Method for disposing of battery” above; thus, the descriptions herein are omitted.

### 2. Monitoring Device

The monitoring device in the present disclosure is configured to monitor the concentration of the additive in the treatment liquid. Examples of the monitoring device that monitors the concentration of the additive may include a liquid concentration meter. Examples of the kinds of the liquid concentration meter may include a vibration type (ultrasonic type), a viscosity type, a spectroscopy type, and an electromagnetic guidance type. For example, by combining the ultrasonic and conductivity measurement, the liquid concentration meter is capable of accurately measure the concentration of the additive in the treatment liquid.

The monitoring device may be configured to monitor a temperature of the treatment liquid. By monitoring the temperature of the treatment liquid, the later described judging device is capable of accurately judging whether the concentration of the additive in the treatment liquid is the threshold value or more or not. Examples of the monitoring device that monitors the temperature of the treatment liquid may include a thermometer. Examples of the kinds of the thermometer may include a bimetal type, a thermocouple type, and a semiconductor type.

### 3. Judging Device

The judging device in the present disclosure is configured to judge the concentration of the additive in the treatment liquid. In specific, the judging device is configured to judge whether a concentration of the additive in the treatment liquid is a threshold value or more or not based on the concentration of the additive obtained by the monitoring device.

The judging device includes a CPU (Central Processing Unit), a memory, and an input and output port that inputs and outputs various signals. Examples of the memory may include ROM (Read Only Memory), RAM (Random Access Memory), and rewritable non-volatile memory. When the CPC executes programs memorized in the memory, various controls run.

The judging device includes at least an acquisition unit and a determination unit as processing blocks configured to achieve its functions. The acquisition unit is configured to acquire the concentration of the additive from the monitoring device. The determination unit determines whether a concentration of the additive is a threshold value or more or not based on the concentration of the additive acquired by the acquisition unit. The threshold value may be, for example, set to the minimum concentration C_{MIN} determined based on the concentration map produced by the prior measurement, and may be set to the value obtained by adding surplus to the minimum concentration C_{MIN}.

When the monitoring device monitors the temperature of the treatment liquid, the acquisition unit may be set to acquire the temperature of the treatment liquid from the monitoring device. In this case, the determination unit preferably determines whether a concentration of the additive is the threshold value or more or not based on the concentration of the additive and the temperature of the treatment liquid acquired by the acquisition unit. The threshold value may be, for example, set to the minimum concentration C_{MIN} determined based on the concentration-temperature map produced by the prior measurement, or may be set to the value obtained by adding surplus to the minimum concentration C_{MIN}.

### 4. Concentration Adjusting Device

The concentration adjusting device in the present disclosure is configured such that, when the judging device judges a concentration of the additive is less than the threshold value, the concentration adjusting device puts the additive in the treating bath to adjust the concentration of the additive to a minimum concentration C_{MIN}, that is capable of preventing the Al terminal from eluting, or more.

The concentration adjusting device may add the additive in a solid state to the treatment liquid, and may add the additive in a state of a high concentration treatment liquid, which is made by dissolving the additive in a high concentration, to the treatment liquid. The high concentration treatment liquid is a treatment liquid of which concentration of the additive is higher than that of the treatment liquid in the treating bath.

### 5. Battery Treatment System

The battery treatment system in the present disclosure may include a temperature adjusting device configured to adjust the temperature in the treating bath based on the temperature of the treatment liquid obtained by the monitoring device. Examples of the temperature adjusting device may include a heating body that heats the treating bath, and a heating body that heats the treatment liquid. Also, the battery treatment system in the present disclosure may include an agitating device configured to agitate the treatment liquid in the treating bath. By arranging the agitating device, the temperature of the treatment liquid can be uniformed, and the additive added to the treating bath by the concentration adjusting device can be uniformly dispersed.

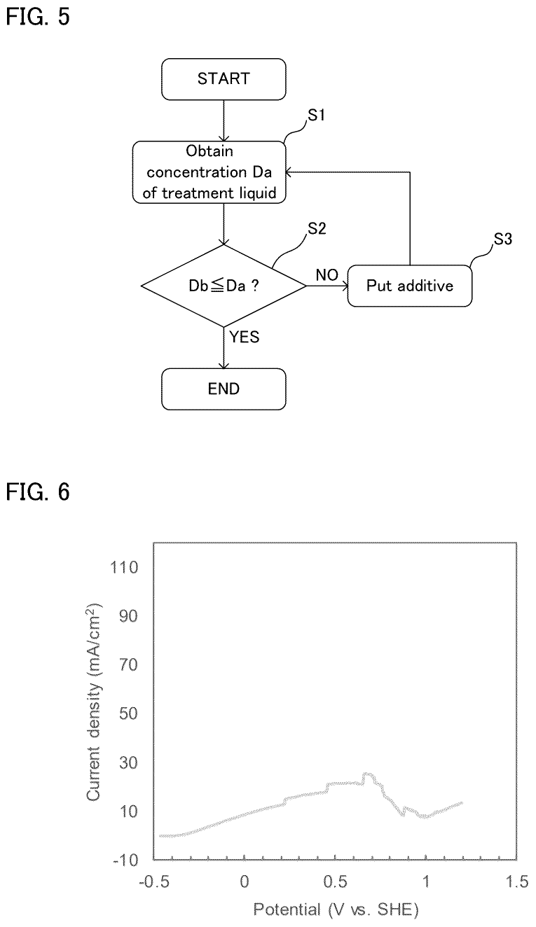

FIG. 5 is a flow chart exemplifying a treatment flow of the battery treatment system in the present disclosure. As shown in FIG. 5, in step S1, the judging device obtains concentration Da of the additive in the treatment liquid from the monitoring device. After that, in step S2, the judging device judges whether the concentration Da of the additive is concentration Db set as a threshold value or more or not. When the concentration Da of the additive is the concentration Db set as a threshold value or more, the treatment flow ends. Meanwhile, when the concentration Da of the additive is less than the concentration Db set as a threshold value, in step S3, the concentration adjusting device puts the additive in the treatment liquid, and then returns to step S1. Alternatively, although not illustrated in particular, the treatment flow may end after putting the additive. The treatment flow is, for example, preferably repeated in a specified interval.

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Reference Comparative Example 1

A batch cell for battery evaluation (SB1A, from EC FRONTIER CO., LTD.) was prepared, and a cell was produced in the following conditions:
Working electrode: Al foil
Counter electrode: Ni foil
Reference electrode: Ag—AgCl electrode (from BAS)
Liquid electrolyte: KCl aqueous solution of 3.5 weight %.

To the produced cell, a linear sweep voltammetry (LSV) measurement was performed. The measurement conditions were as follows.
Sweeping speed: 1 mV/s
Measurement temperature: 25° C. (The cell was stored in a thermostatic tank for 8 hours or more, and then the LSV measurement was performed.)

Sweeping range: from OCP until 1.0 V vs. Ag/AgCl (1.2V vs. SHE)

The result of the LSV measurement is shown in FIG. 6. As shown in FIG. 6, in Reference Comparative Example 1, it was confirmed that the current density gradually increased from the beginning of the measurement until about 0.7 V. The increase of the current density is caused by the elution of Al.

### Comparative Example 1-1 and Examples 1-1, 1-2, 1-3

KCl aqueous solution of 3.5 weight % was prepared, and further, K₂SiO₃ (additive) was added thereto and agitated. The concentration of K₂SiO₃ was, on the basis of the H₂O weight of the KCl aqueous solution, respectively 0.1 mol/kg, 0.5 mol/kg, 1.0 mol/kg, and 2.0 mol/kg. After agitating, the mixture was placed still in a thermostatic tank at 25° C., over one night, and thereby a liquid electrolyte was obtained. A cell was respectively produced in the same manner as in Reference Comparative Example 1, except that the obtained liquid electrolyte was respectively used, and the LSV measurement was respectively performed.

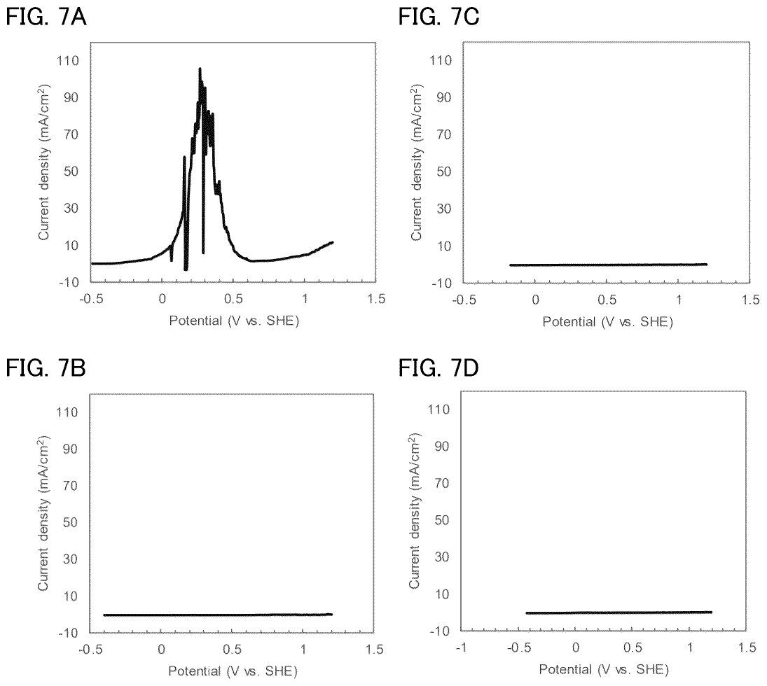

The results of the LSV measurements are shown in FIGS. 7A to 7D. As shown in FIG. 7A, in Comparative Example 1-1, it was confirmed that the current density sharply increased from about 0 V. Also, when FIG. 7A is compared to FIG. 6, in Comparative Example 1-1, the current density increased more than Reference Comparative Example 1. This is presumably because the concentration of K₂SiO₃ was low and it was not possible to form the passive state film on the Al foil, but the conductivity of the treatment liquid was improved by K₂SiO₃. Also, there are possibilities that the deposition of hydroxide occurred, and a hole was formed on the Al foil due to the rapid progress of Al elution. Meanwhile, as shown in FIGS. 7B, 7C, and 7D, the increase of the current density was rarely confirmed in Examples 1-1, 1-2, and 1-3. Also, when FIGS. 7B, 7C, and 7D are compared to FIG. 6, it was confirmed that the elution of Al was prevented more in Examples 1-1, 1-2, and 1-3 compared to Reference Comparative Example 1.

### Comparative Example 2-1 and Examples 2-1, 2-2, 2-3

KCl aqueous solution of 3.5 weights was prepared, and further, K₃PO₄ (additive) was added thereto and agitated. The concentration of K₃PO₄ was, on the basis of the H₂O weight of the KCl aqueous solution, respectively 0.1 mol/kg, 0.5 mol/kg, 1.0 mol/kg, and 2.0 mol/kg. After agitating, the mixture was placed still in a thermostatic tank at 25° C., over one night, and thereby a liquid electrolyte was obtained. A cell was respectively produced in the same manner as in Reference Comparative Example 1, except that the obtained liquid electrolyte was respectively used, and the LSV measurement was respectively performed.

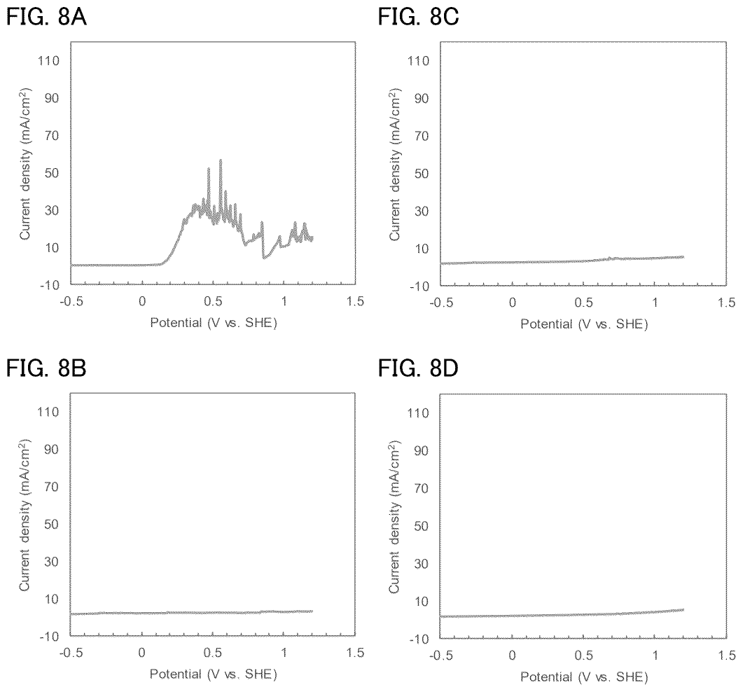

The results of the LSV measurements are shown in FIGS. 8A to 8D. As shown in FIG. 8A, in Comparative Example 2-1, it was confirmed that the current density sharply increased from about 0.2 V. Also, when FIG. 8A is compared to FIG. 6, the current density of Comparative Example 2-1 increased more than Reference Comparative Example 1. This was presumably because the concentration of K₃PO₄ was low and it was not possible to form the passive state film on the Al foil, but the conductivity of the treatment liquid was improved by K₃PO₄. Meanwhile, as shown in FIGS. 8B, 8C, and 8D, the increase of the current density is rarely confirmed in Examples 2-1, 2-2, and 2-3. Also, when FIGS. 8B, 8C, and 8D are compared to FIG. 6, it was confirmed that the elution of Al was prevented more in Examples 2-1, 2-2, and 2-3 compared to Reference Comparative Example 1.

### Comparative Examples 3-1, 3-2 and Examples 3-1, 3-2

KCl aqueous solution of 3.5 weight % was prepared, and further, K₄P₂O₇ (additive) was added thereto and agitated. The concentration of K₄P₂O₇ was, on the basis of the H₂O weight of the KCl aqueous solution, respectively 0.1 mol/kg, 0.5 mol/kg, 1.0 mol/kg, and 2.0 mol/kg. After agitating, the mixture was placed still in a thermostatic tank at 25° C., over one night, and thereby a liquid electrolyte was obtained. A cell was respectively produced in the same manner as in Reference Comparative Example 1, except that the obtained liquid electrolyte was respectively used, and the LSV measurement was respectively performed.

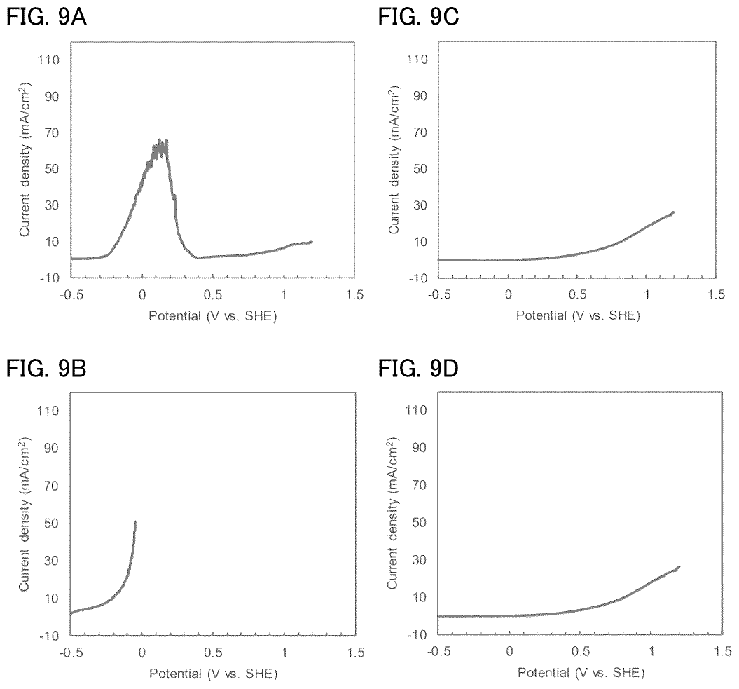

The results of the LSV measurements are shown in FIGS. 9A to 9D. As shown in FIGS. 9A and 9B, in Comparative Example 2-1 and Comparative Example 2-2, it was confirmed that the current density sharply increased from about −0.2 V. Also, when FIGS. 9A and 9B are compared to FIG. 6, the current density in Comparative Example 2-1 and Comparative Example 2-2 increased more than Reference Comparative Example 1. This was presumably because the concentration of K₄P₂O₇ was low and it was not possible to form the passive state film on the Al foil, but the conductivity of the treatment liquid was improved by K₄P₂O₇. Meanwhile, as shown in FIGS. 9C and 9D, in Examples 3-1 and 3-2, the increase of the current density was slightly confirmed. However, when FIGS. 9C and 9D are compared to FIG. 6, it was confirmed that the elution of Al was prevented more in Examples 3-1 and 3-2 compared to Reference Comparative Example 1 (in particular, elution of Al rarely occurred around 0.5 V).

### Comparative Example 4-1

KCl aqueous solution of 3.5 weight % was prepared, and further, K₂SO₄ (additive) was added thereto and agitated.

The concentration of K₂SO₄ was the saturated concentration. After agitating, the mixture was placed still in a thermostatic tank at 25° C., over one night, and thereby a liquid electrolyte was obtained. A cell was produced in the same manner as in Reference Comparative Example 1, except that the obtained liquid electrolyte was used, and the LSV measurement was performed.

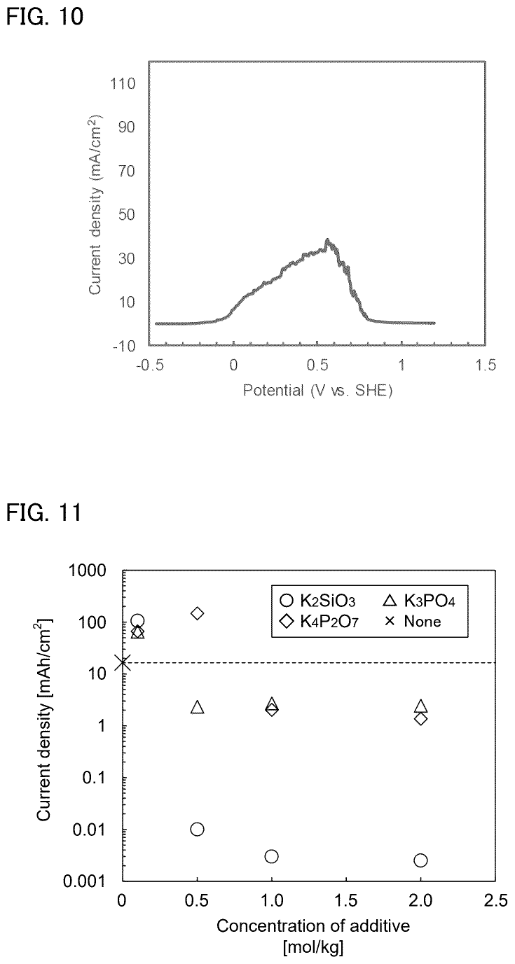

The result of the LSV measurement is shown in FIG. 10. As shown in FIG. 10, in Comparative Example 4-1, it was confirmed that the current density gradually increased from about −0.1 V until about 0.6 V. Also, when FIG. 10 is compared to FIG. 6, the current density in Comparative Example 4-1 increased more than Reference Comparative Example 1. This is presumably because K₂SO₄ was presumably not capable of forming the passive state film on the Al foil, and the conductivity of the treatment liquid was improved by K₂SO₄.

The results of each Examples, each Comparative Examples, and Reference Comparative Example 1 described above are shown in Table 1.

TABLE 1

| | Additive | | | | | | |
|---|---|---|---|---|---|---|---|
| | | Concentration | Current density [mAh/cm²] | | | | |
| | Kind | [mol/kg] | 0.5 V | 0.6 V | 0.8 V | 1.0 V | Max |
| Ref. Comp. Ex. 1 | — | — | 16.52 | 17.54 | 21.06 | 12.36 | 25.23 |
| Comp. Ex. 1-1 | K₂SiO₃ | 0.1 | 82.9 | 28.12 | 1.46 | 2.27 | 105.94 |
| Example 1-1 | K₂SiO₃ | 0.5 | 0.01 | 0.01 | 0.03 | 0.17 | 0.92 |
| Example 1-2 | K₂SiO₃ | 1.0 | <0.01 | <0.01 | <0.01 | 0.01 | 0.02 |
| Example 1-3 | K₂SiO₃ | 2.0 | <0.01 | <0.01 | <0.01 | <0.01 | 0.01 |
| Comp. Ex. 2-1 | K₃PO₄ | 0.1 | 26.00 | 29.67 | 24.51 | 15.64 | 65.03 |
| Example 2-1 | K₃PO₄ | 0.5 | 2.32 | 2.21 | 2.31 | 2.34 | 3.26 |
| Example 2-2 | K₃PO₄ | 1.0 | 2.69 | 2.85 | 3.65 | 4.27 | 6.01 |
| Example 2-3 | K₃PO₄ | 2.0 | 2.44 | 2.55 | 2.90 | 3.47 | 6.98 |
| Comp. Ex. 3-1 | K₄P₂O₇ | 0.1 | 4.49 | 0.95 | 1.84 | 3.45 | 66.11 |
| Comp. Ex. 3-2 | K₄P₂O₇ | 0.5 | — | — | — | — | 147.46 |
| Example 3-1 | K₄P₂O₇ | 1.0 | 2.02 | 3.25 | 7.14 | 11.48 | 15.85 |
| Example 3-2 | K₄P₂O₇ | 2.0 | 1.36 | 2.33 | 5.28 | 10.58 | 27.45 |
| Comp. Ex. 4-1 | K₂SO₄ | sat. | 26.19 | 31.71 | 32.10 | 1.47 | 38.57 |

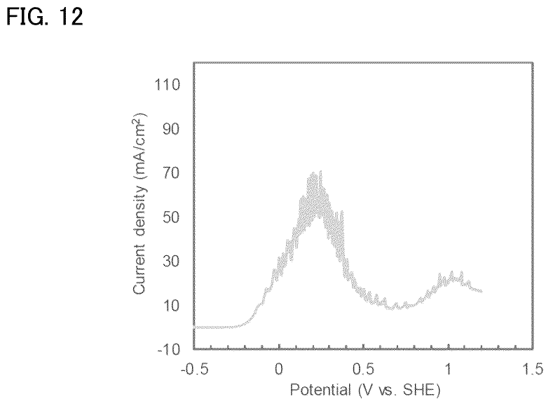

Also, the relation between the concentration of additive and the current density is shown in FIG. 11. In FIG. 11, basically, the current density at 0.5 V was plotted. Meanwhile, for example, as shown in FIG. 7A, when a peak of the current density is confirmed at a lower potential than 0.5 V, the maximum value of the current density (Max in Table 1) was plotted. As shown in FIG. 11, it was confirmed that the elution of Al was prevented by adding the specified additive in the specified concentration. In particular, K₂SiO₃ was remarkably capable of preventing Al from eluting. Also, the value of the current density in Reference Comparative Example 1 shown in FIG. 11 is the basis to determine the minimum concentration C_{MIN}.

### Reference Comparative Example 2

A LSV measurement was performed in the same manner as in Reference Comparative Example 1, except that the measurement temperature of the LSV measurement was changed to 0° C. (the cell was stored in a thermostatic tank for 8 hours or more, and then the LSV measurement was performed). The result is shown in FIG. 12 and Table 2. As shown in FIG. 12 and Table 2, in Reference Comparative Example 2, it was confirmed that the current density sharply increased from about 0.2 V.

### Examples 4-1, 4-2, 5-1, 6-1

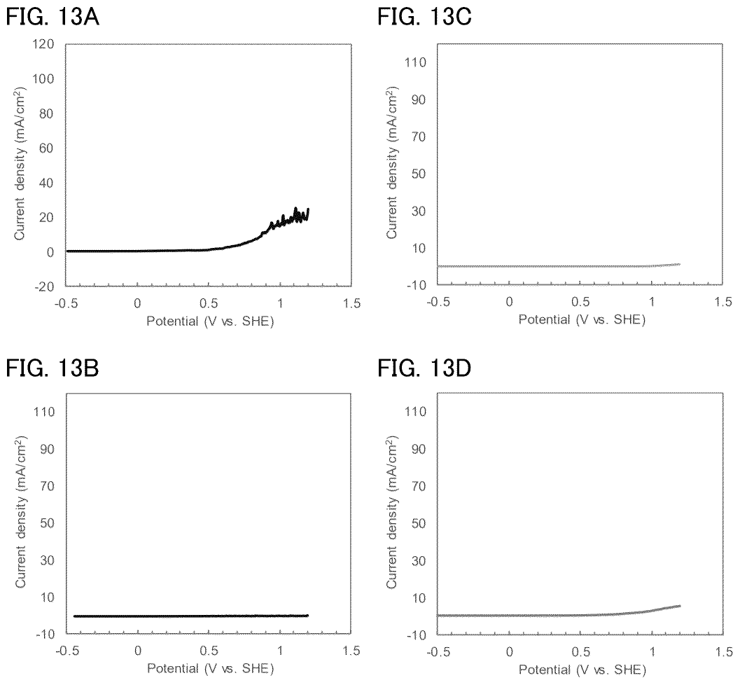

Cells were respectively produced in the same manner as in Reference Comparative Example 2, except that liquid electrolytes produced in the same manners as in Comparative Example 1-1, Example 1-1, Example 2-1, and Comparative Example 3-2 were respectively used, and the LSV measurement was respectively performed. The results are shown in FIGS. 13A to 13D and Table 2.

TABLE 2

| | Additive | | | | | | |
|---|---|---|---|---|---|---|---|
| | | Concen- | | | | | |
| | | tration | Current density [mAh/cm²] | | | | |
| | Kind | [mol/kg] | 0.5 V | 0.6 V | 0.8 V | 1.0 V | Max |
| Ref. Comp. | — | — | 48.95 | 22.38 | 13.35 | 11.40 | 70.75 |
| Ex. 2 | | | | | | | |
| Example 4-1 | K₂SiO₃ | 0.1 | 0.41 | 0.46 | 2.23 | 6.76 | 27.42 |
| Example 4-2 | K₂SiO₃ | 0.5 | 0.02 | 0.02 | 0.10 | 0.04 | 0.32 |
| Example 5-1 | K₃PO₄ | 0.5 | 0.01 | 0.01 | 0.01 | 0.02 | 1.25 |
| Example 6-1 | K₄P₂O₇ | 0.5 | 0.18 | 0.22 | 0.47 | 1.34 | 5.65 |

As shown in FIG. 13A, in Example 4-1, the increase of the current density was slightly confirmed. However, when FIG. 13A is compared to FIG. 12, it was confirmed that the elution of Al was prevented more in Example 4-1 compared to Reference Comparative Example 2 (in particular, the elution of Al rarely occurred around 0.2 V). Also, as shown in FIGS. 13B, 13C, and 13D, in Examples 4-2, 5-1, and 6-1, the increase of the current density was rarely confirmed. Also, when FIGS. 13B, 13C, and 13D are compared to FIG. 12, it was confirmed that the elution of Al was prevented more in Examples 4-2, 5-1, and 6-1 compared to Reference Comparative Example 2.

When FIG. 12 is compared to the above described FIG. 6, since the additive is not used in Reference Comparative Example 1 and Reference Comparative Example 2, the elution of Al occurred at both 0°° C. and 25° C. Meanwhile, when FIG. 13A is compared to the above described FIG. 7A, it was confirmed that the elution of Al was prevented by controlling the temperature of the treatment liquid even when the concentration of K₂SiO₃ was low. Also, when FIG. 13B is compared to the above described FIG. 7B, K₂SiO₃ was capable of remarkably preventing Al from eluting at both 0° C. and 25° C. Also, when FIG. 13C is compared to the above described FIG. 8B, K₃PO₄ was capable of remarkably preventing Al from eluting at both 0°° C. and 25° C. Meanwhile, when FIG. 13D is compared to the above described FIG. 9B, it was confirmed that the elution of Al was prevented by controlling the temperature of the treatment liquid even when the concentration of K₄P₂O₇ was low.

### REFERENCE SINGS LIST

1 anode current collector
2 anode active material layer
3 electrolyte layer
4 cathode active material layer
5 cathode current collector
10 electrode body
20 outer package
30 terminal
40 treating bath
50 treatment liquid
100 battery

What is claimed is:

1. A method for disposing of a battery, the method comprising:
a soaking step of soaking a battery including an Al terminal in a treatment liquid to decrease a voltage of the battery by causing outer short circuit through the treatment liquid, wherein
the treatment liquid contains water, a supporting salt, and an additive that prevents the Al terminal from eluting; and
a concentration of the additive in the treatment liquid is a minimum concentration C_{MIN}, that is capable of preventing the Al terminal from eluting, or more.

2. The method for disposing of a battery according to claim 1, wherein the additive includes a phosphate-based anion, a silicate-based anion, an imide-based anion, or a carboxylic acid-based anion, as an anion component.

3. The method for disposing of a battery according to claim 2, wherein the phosphate-based anion is a phosphate ion, a phosphite ion, a hypophosphite ion, or a polyphosphate ion.

4. The method for disposing of a battery according to claim 2, wherein the silicate-based anion is an orthosilicate ion, a methsilicate ion, or a polysilicate ion.

5. The method for disposing of a battery according to claim 2, wherein the additive includes an alkali metal ion as a cation component.

6. The method for disposing of a battery according to claim 5, wherein the alkali metal ion is a potassium ion.

7. The method for disposing of a battery according to claim 1, wherein the concentration of the additive in the treatment liquid is 0.5 mol/kg or more.

8. The method for disposing of a battery according to claim 1, wherein the concentration of the additive in the treatment liquid is 1.0 mol/kg or more.

9. The method for disposing of a battery according to claim 1, wherein a temperature of the treatment liquid in the soaking step is 0°° C. or more and 60° C. or less.

10. The method for disposing of a battery according to claim 1, wherein the battery includes a laminate type outer package.

11. The method for disposing of a battery according to claim 1, wherein the battery is a solid state battery.

12. A battery treatment system comprising:
a treating bath configured to perform a treatment to a battery including an Al terminal by a treatment liquid that contains water, a supporting salt, and an additive that prevents the Al terminal from eluting;
a monitoring device that monitors a concentration of the additive in the treatment liquid;
a judging device that judges a concentration of the additive in the treatment liquid; and
a concentration adjusting device that adjusts a concentration of the additive in the treatment liquid, wherein
the judging device judges whether a concentration of the additive is a threshold value or more or not based on the concentration of the additive obtained by the monitoring device; and
when the judging device judges a concentration of the additive is less than the threshold value, the concentration adjusting device puts the additive in the treating bath to adjust the concentration of the additive to a minimum concentration C_{MIN}, that is capable of preventing the Al terminal from eluting, or more.

13. The battery treatment system according to claim 12, wherein
the monitoring device further monitors a temperature of the treatment liquid; and
the judging device judges whether a concentration of the additive is a threshold value or more or not based on the concentration of the additive and the temperature of the treatment liquid obtained by the monitoring device.
